(19) United States
(12) Patent Application Publication
(10) Pub. No.: US 2006/0102685 A1
(43) Pub. Date: May 18, 2006

(54) Top load/side load adjustable angle magazine

(76) Inventors: Alan Phillips, Jackson, TN (US); Barbara A. Rose, Jackson, TN (US)

Correspondence Address: THE BLACK & DECKER CORPORATION, 701 EAST JOPPA ROAD, TW199, TOWSON, MD, 21286, US

(21) Appl. No.: 10/665,737

(22) Filed: Sep. 17, 2003

Related U.S. Application Data
(60) Provisional application No. 60/411,563, filed on Sep. 18, 2002.
(60) Provisional application No. 60/471,641, filed on May 19, 2003.

(51) Int. Cl. B25C 5/06

(52) U.S. Cl. 227/120; 227/136

(57) ABSTRACT

An adjustable angle magazine comprising a loading mechanism is pivotally coupled with a nail gun to enable nail gun operation with a variety of nail types and collation angles. The loading mechanism is one of a top-load mechanism and a side-load mechanism.

### CROSS REFERENCE TO RELATED APPLICATION

The present application claims priority under 35 U.S.C. §119(e) to the U.S. Provisional Application Ser. No. 60/411,563, filed on Sep. 18, 2012, and the U.S. Provisional Application Ser. No. 60/471,641, filed on May 19, 2013. The U.S. Provisional Applications 60/411,563 and 60/471,641 are herein incorporated by reference in their entireties.

### FIELD OF THE INVENTION

The present invention generally relates to the field of power tools, and particularly to a nail loading mechanism employed with an adjustable angle magazine for a nail gun, such as a pneumatic nail gun.

### BACKGROUND OF THE INVENTION

The use of power tools, such as nail guns is commonplace in the construction industry. Devices, such as the nails employed with nail guns, are often provided in collated strips. These collated strips of nails are typically loaded into a nail loading assembly, often identified as the nail gun magazine. The nail gun magazine provides storage capabilities for the nails as well as the ability to present the nails to a nail driving assembly of the nail gun.

Typically, the loading of the nails into the magazine occurs through the end of the magazine opposite the end engaged with the nail driving assembly of the nail gun. Further, it is commonly the case that these magazines may require the nails be collated at a particular angle to enable functionality with the nail gun. Thus, it is often the case that particular strips of collated nails are limited in their application to particular nail guns.

Therefore, it would be desirable to provide a magazine which enables nail gun functionality with a variety of nails and allows for the loading of the nails through other than a back end.

### SUMMARY OF THE INVENTION

Accordingly, the present invention is directed to an adjustable angle magazine with a loading mechanism that enables nails to be loaded into the magazine through a top-load mechanism or a side-load mechanism. In a first aspect of the present invention, an adjustable angle magazine comprising a housing including a first end, a second end, and a tope side, the housing stores and provides nails to a nail driving assembly of a nail gun. An adjustment assembly is disposed proximal to the second end of the housing, the adjustment assembly for affixing the position of the housing relative to the nail gun. A universal adapter assembly is coupled to a first end of the adjustable angle magazine and enables the pivoting coupling of the adjustable angle magazine with the nail driving assembly. A top loading mechanism is disposed upon the top side of the housing and enables the loading of the nails into the housing through the top side.

In a second aspect of the present invention, an adjustable angle magazine comprising a housing, including a first end and a second end, coupled with a cover, the housing stores and provides nails to a nail driving assembly of a nail gun. The cover includes a first side and provides a closed system to the adjustable angle magazine. An adjustment assembly is disposed proximal to the second end of the housing, the adjustment assembly for affixing the position of the housing relative to the nail gun. A universal adapter assembly is coupled to a first end of the adjustable angle magazine and enables the pivoting coupling of the adjustable angle magazine with the nail driving assembly. A side loading mechanism is disposed upon the first side of the cover and enables the loading of the nails into the housing through the first side.

In a third aspect of the present invention, an adjustable angle nail gun is provided. The adjustable angle nail gun comprises a handle with a first end and a second end coupled with a fastening assembly. A nail driving assembly including a driver blade is coupled with the first end of the handle and is for driving nails in a collated nail strip. An adjustable angle nose casting assembly is coupled with the nail driving assembly. The adjustable angle nose casting assembly enables the operational engagement of the driver blade with the nail. An adjustable angle magazine, including a top side, for storing and providing the nails is pivotally coupled with the adjustable angle nose casting assembly. A universal adapter assembly is coupled with a first end of the adjustable angle magazine and enables the pivotal coupling of the adjustable angle magazine with the adjustable angle nose casting assembly. An adjustment assembly disposed proximal to the second end of the adjustable angle magazine couples with the fastening assembly. A top loading mechanism is disposed upon the top side of the adjustable angle magazine and enables the loading of the nails into the adjustable angle magazine through the top side.

In a fourth aspect of the present invention, an adjustable angle nail gun is provided. The adjustable angle nail gun comprises a handle with a first end and a second end coupled with a fastening assembly. A nail driving assembly including a driver blade is coupled with the first end of the handle and is for driving nails in a collated nail strip. An adjustable angle nose casting assembly is coupled with the nail driving assembly. The adjustable angle nose casting assembly enables the operational engagement of the driver blade with the nail. An adjustable angle magazine, including a side, for storing and providing the nails is pivotally coupled with the adjustable angle nose casting assembly. A universal adapter assembly is coupled with a first end of the adjustable angle magazine and enables the pivotal coupling of the adjustable angle magazine with the adjustable angle nose casting assembly. An adjustment assembly disposed proximal to the second end of the adjustable angle magazine couples with the fastening assembly. A side loading mechanism is disposed upon the side of the adjustable angle magazine and enables the loading of the nails into the adjustable angle magazine through the side.

It is to be understood that both the forgoing general description and the following detailed description are exemplary and explanatory only and are not restrictive of the invention as claimed. The accompanying drawings, which are incorporated in and constitute a part of the specification, illustrate an embodiment of the invention and together with the general description, serve to explain the principles of the invention.

### BRIEF DESCRIPTION OF THE DRAWINGS

The numerous advantages of the present invention may be better understood by those skilled in the art by reference to the accompanying figures in which:

FIG. 1 is an illustration of an adjustable angle nail gun assembly including an adjustable angle magazine, a housing, a cover, a universal adapter assembly, and a top loading mechanism in accordance with an exemplary embodiment of the present invention;

FIG. 2 is an illustration of an adjustable angle nail gun assembly including an adjustable angle magazine, a housing, a cover, a universal adapter assembly, and a side loading mechanism in accordance with an exemplary embodiment of the present invention;

FIG. 3 is a view of the adjustable angle magazine accepting a collated nail strip via a top loading mechanism; and

FIG. 4 is a view of the adjustable angle magazine accepting a collated nail strip via a side loading mechanism; and

FIG. 5 is an isometric illustration of an adjustable angle nail gun including an adjustable angle magazine comprising a housing with a cover slidably coupled with the housing for the loading of a collated nail strip.

### DETAILED DESCRIPTION OF THE INVENTION

Reference may now be made in detail to the presently preferred embodiments of the invention, examples of which are illustrated in the accompanying drawings.

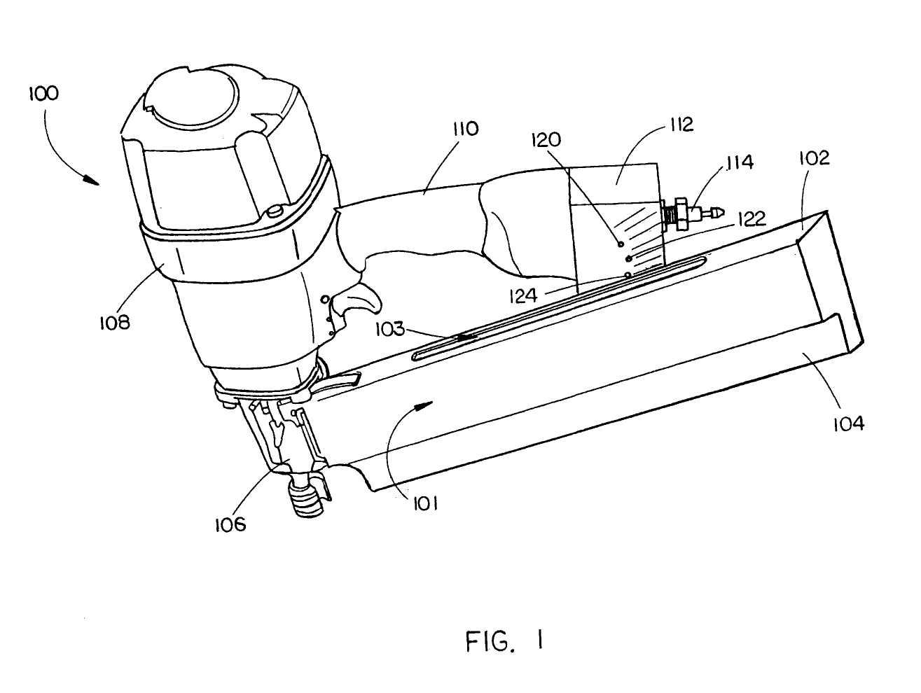

Referring generally now to FIGS. 1 through 5, exemplary embodiments of the present invention are shown.

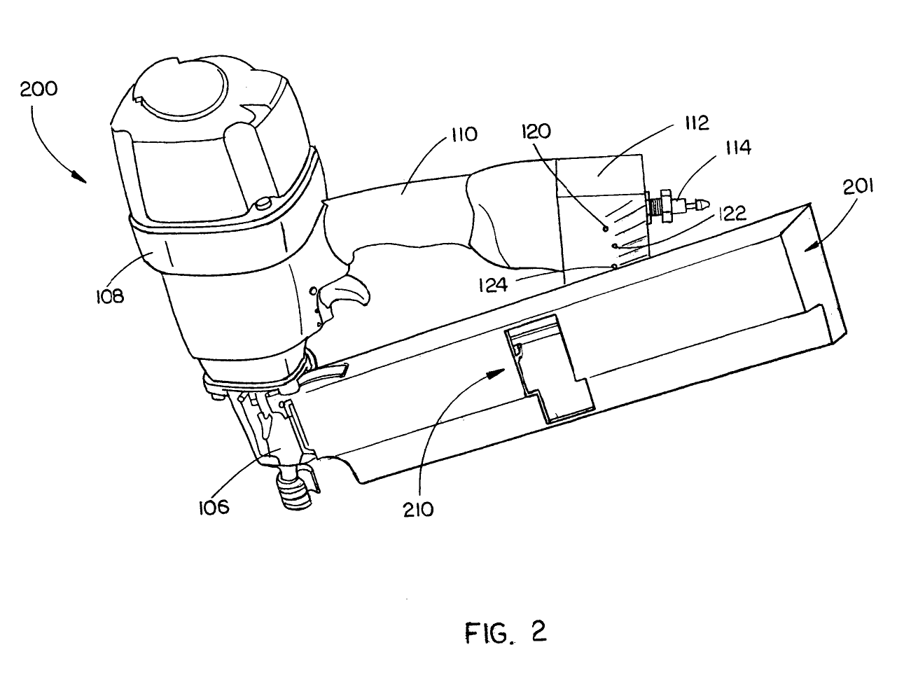

Referring now to FIGS. 1 and 2, a nail gun assembly 100 including an adjustable angle magazine 101 and a nail gun assembly 200 including an adjustable angle magazine 201, are shown. The adjustable angle magazine 101 includes a housing 102 coupled with a cover 104, a universal adapter assembly, and a loading mechanism. In FIG. 1, the adjustable angle magazine 101 is shown including a top-loading mechanism 103. In FIG. 2, the adjustable angle magazine 201 is similar in all respects to the adjustable angle magazine 101 except that the adjustable angle magazine 201 is shown including a side loading mechanism 210. The adjustable angle magazine 101 and 201 provides the operator of the nail gun 100 and 200, respectively, the ability to use a variety of nail types collated at a variety of angles within the same nail gun.

It is understood that description provided for the adjustable angle magazine 101 and its components are intended to be descriptive of the adjustable angle magazine 201 and its components except for the nail loading mechanisms identified above. The housing 102 is configured generally to appear as a standard nail gun magazine with the cover 104 coupled with it. The housing 102 may be configured for operation without the cover 104. In alternative embodiments, the housing 102 may be coil-type housing where the connected nails are arranged in a long belt, which winds around a spool. The coil-type housing may be configured in a variety of ways, such as a horizontal coil-type housing or a vertical coil-type housing. The cover 104 may be configured to operate with alternative embodiments, such as the coil-type housing, or may not be included. It is understood that alternative design embodiments of the housing 102 and cover 104 may be employed and do not depart from the scope and spirit of the present invention.

It is contemplated that both embodiments 100 and 200, the top-load and side-load adjustable angle magazines, may include a mechanism, such as an articulating pusher assembly, disposed within the adjustable angle magazine 101 and 201. The articulating pusher assembly engages with the nails after the nails have been loaded into the adjustable angle magazine 101 and 201 either through the top-load or side-load mechanism. It is understood that the articulating pusher assembly may be adjusted within the adjustable angle magazine 101 and 201. For example, a mechanical assembly may include a handle engaged by the operator, disposed on the adjustable angle magazine 101 and 201. The handle may connect with the articulating pusher assembly and allow the operator to slide the articulating pusher assembly up and down the length of the adjustable angle magazine 101 and 201. The direction of movement of the articulating pusher assembly may be determined by the direction of movement of the handle. The operator may manually move the articulating pusher assembly away from the end of the adjustable angle magazine 101 and 201 which couples with the adjustable angle nose casting assembly 106 in order to load the nails. It is contemplated that the system employed to accomplish this operator directed movement of the articulating pusher assembly may be a variety of systems, including pneumatic, hydraulic, and the like.

Further, a universal adapter assembly may couple with the top or side load adjustable angle magazine 101 and 201. The universal adapter assembly would facilitate the adjustable angle magazines in achieving its range of motion. Preferably, the universal adapter assembly may comprise a seating member coupled with a rail member. The seating member may be designed for engaging a cradle of an adjustable angle nose casting assembly 106. The seating member may comprise a first arm coupled with a second arm. The seating member may further comprise a notch which is coupled with the first and second arm. A transition plate may be coupled to the second arm of the seating member. The first and second arm may be configured with rounded heads for engagement with the cradle. This rounded head configuration may enable rotational movement of the seating member once engaged with the cradle. The notch may be disposed across both the first and second arm, and may be engaged by a cradle fastening assembly to secure its position. Preferably, the notch may comprise a smooth surface to allow the cradle fastening assembly to slide upon it thereby enabling the rotational movement of the seating member.

The transition plate may be designed to provide a connection to the adjustable angle magazine 101 and 201. The transition plate may engage with the adjustable angle magazines to securely affix the seating member. The rail member may provide further connection to the adjustable angle magazines. The rail member may couple along a side of the adjustable angle magazines. In one contemplated embodiment, the rail member may be disposed with a first fastening point and a second fastening point. Preferably, the first and second fastening points are apertures through the rail member. The apertures may allow a fastener, such as a bolt, screw, clip, pin, and the like, to affix the rail member to a surface, such as the adjustable angle magazines. It is understood that the fastening points located on both the universal adapter assembly and the housing may be located in various positions. Further, the method of fastening the universal adapter assembly to the housing may be varied. For example, the universal adapter assembly may be locked in place through a compression lock assembly with a release button assembly to allow for removal from the housing.

It is also contemplated that in an alternative embodiment, the housing and universal adapter assembly may couple with a compression cover. The compression cover may engage with the housing through a compression lock system comprising a plurality of compression clips disposed on the cover and through points disposed on the housing. Other systems and methods of coupling the cover to the housing may be employed as contemplated by one of ordinary skill in the art.

Further, the adjustable angle magazine 101 and 201 of the present invention may be disposed with various other devices and mechanisms. These may include a pick-off pivot assembly, a nail checker assembly, a nail lockout assembly, a nail spacing verification assembly, a nail shank pawl assembly, and a pinion nail verification assembly.

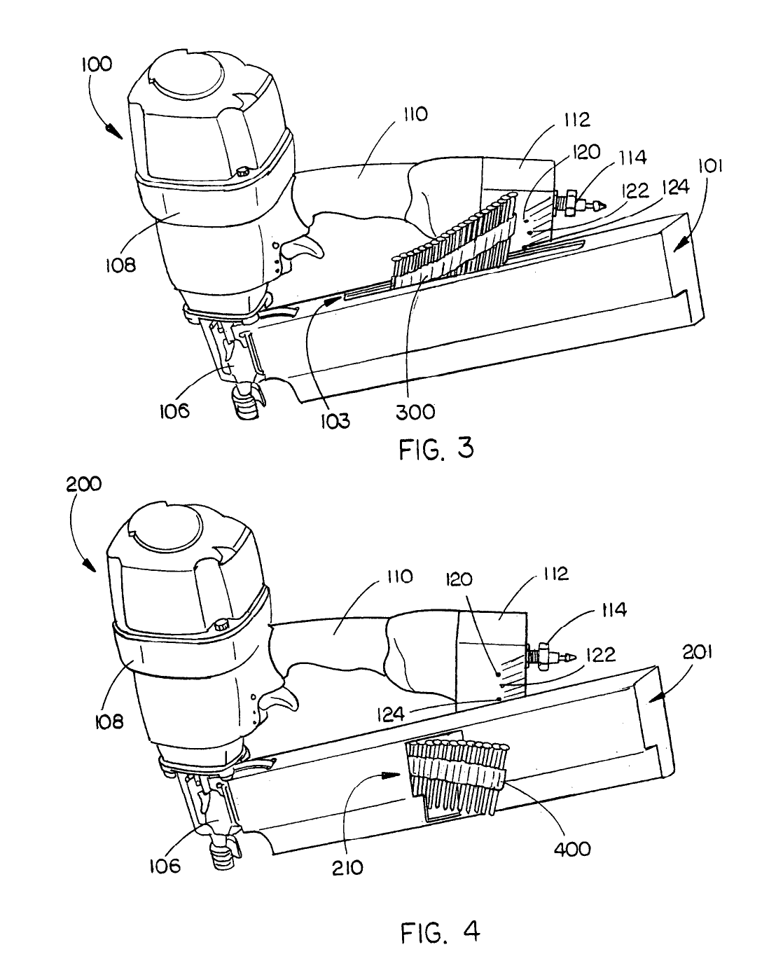

Referring now to FIG. 3, the adjustable angle nail gun assembly 100 including the top-load adjustable angle magazine 101 having a collated strip of nails 300 loaded through the top loading mechanism 103, is shown. FIG. 4, shows the adjustable angle nail gun assembly 200 including the side-load adjustable angle magazine 201 having a collated strip of nails 400 loaded through the side loading mechanism 210. The adjustable angle nail gun assembly 100 includes the top-load adjustable angle magazine 101 coupled with an adjustable angle nose casting assembly 106 and a fastening assembly 112. The adjustable angle nose casting assembly 106 is further coupled with a housing 102, which is disposed with a nail driving assembly including a driver blade that operationally engages with the adjustable angle nose casting assembly 106 and an actuator for controlling the functioning of the nail driving assembly. The housing 102 is coupled with a handle 110 which is coupled with an air compressor assembly. The handle 110 also couples with the fastening assembly 112.

The fastening assembly 112 includes a plurality of angular adjustment sites, as exemplified by a first angular adjustment site 120, a second angular adjustment site 122 and a third angular adjustment site 124. The fastening assembly 112 is disposed with a plurality of angle identifiers. The angle identifiers are a series of indicators associated with a printed number (i.e., 30, 29, 28, 27 . . . ) which corresponds to the angle of presentation of the adjustable angle magazine 101 to the adjustable angle nose casting assembly 106. It is contemplated that the angle identifiers may be a label with the numbers printed upon them which may be adhered to the fastening assembly 112. Alternatively, the numbers may be engraved or painted upon the fastening assembly 112.

In the current embodiment, it is understood that the plurality of angular adjustment sites may be engaged by a fastener, such as a bolt, screw, pin, and the like. The fastener may engage through the housing 102 via an adjustment assembly comprising a first angular connection site and a second angular connection site. Alternatively, the number of angular connection sites may vary as contemplated by one of ordinary skill. The fastener engages through the first or second angular connection site and connects with one of the plurality of angular adjustment sites.

In an alternative embodiment, the fastening assembly employed by the present invention may be variously configured. For example, the fastening assembly may be implemented using a worm drive assembly. In such a configuration, a threaded shaft may be disposed within the fastening assembly and operationally coupled with a threaded sleeve. The threaded sleeve may be enabled to move up and down the threaded shaft through rotation of a mechanical rotation assembly, which couples with the threaded shaft, by an operator of the nail gun. A post coupled with the housing of the adjustable angle magazine may be further coupled to the threaded sleeve, thus enabling the angular adjustment of the adjustable angle magazine. Other configurations may include a pneumatic fastening system, hydraulic fastening system, alternative mechanical systems, and the like. For instance, the fastening assembly may utilize the compressed air provided through the compressor connection assembly by redirecting the flow of a portion of the compressed air into a gauge assembly. The gauge assembly may include a readout which provides a visual indication to the operator of the angle of the nail loading assembly relative to the adjustable angle nose casting assembly of the adjustable angle nail gun. Further, the gauge assembly may include an actuator which may allow the operator of the adjustable angle nail gun to alter the flow of the compressed air into the gauge assembly either increasing or decreasing the flow. Alternatively, the gauge assembly may provide a bleed-off valve assembly enabling the operator to regulate the release of the compressed air in the gauge assembly. Either by increasing and decreasing the air flow or bleeding-off the compressed air the operator may change the angle of the adjustable angle magazine relative to the adjustable angle nose casting assembly. The gauge assembly may control the angle of the adjustable angle magazine via a piston assembly engaging with the housing of the adjustable angle magazine. The piston assembly may include a piston engaging a shaft which is coupled with the housing, thus, as the shaft moves so to does the housing of the adjustable angle magazine. It is understood the piston moves the shaft by reacting to changing air pressures within.

In an alternative embodiment, a mechanical fastening system may include a ratchet assembly with a hand brake. The hand brake is engaged by the operator and through pressure applied to the hand brake the ratchet assembly raises or lowers the housing of the adjustable angle magazine. For example, the hand brake may include a spring loaded snap joint which provides incremental adjustments of the angle of the housing relative to the adjustable angle nose casting assembly. The spring loaded snap joint engages a multi-position actuator which engages the ratcheting assembly. The hand brake may be disposed on the handle of the nail gun assembly to provide easy access and control over the nail gun assembly during operation of the hand brake.

It is contemplated that the top or side load adjustable angle magazine 101 and 201 may include a support assembly comprising a first support member disposed on a cover and a second support member disposed on a housing of the adjustable angle magazine. It is understood that the first and second support members may be disposed on a first and second side of the adjustable angle magazines. The first and second support member may be configured to engage with a first support bar and a second support bar that protrude from an adjustable angle nose casting assembly 106. The engagement of the support bars and members may provide stability to the adjustable angle nail gun during operation. In the preferred embodiment, the first and second support members may comprise a section of the cover and housing, respectively, and include serrated or toothed sections. These serrated or toothed sections of the first and second support member may be designed to engage with complimentary serrated or toothed sections disposed upon the first and second support bar. Additionally, this combination may be designed to be releasably engaged, allowing for the easy adjustment of the angle of the housing relative to the adjustable angle nose casting assembly.

In the alternative the first and second support members may be coupled to the first and second support bars and include a mechanism for concomitant adjustment when the adjustment assembly is re-adjusted. For example, a worm drive assembly may be employed that allows for movement to adjust and then locks in place when the desired position has been reached. Alternatively, a compression lock assembly may be employed to accomplish the same re-positioning enabled by the adjustment assembly in combination with the nail gun fastening assembly discussed previously.

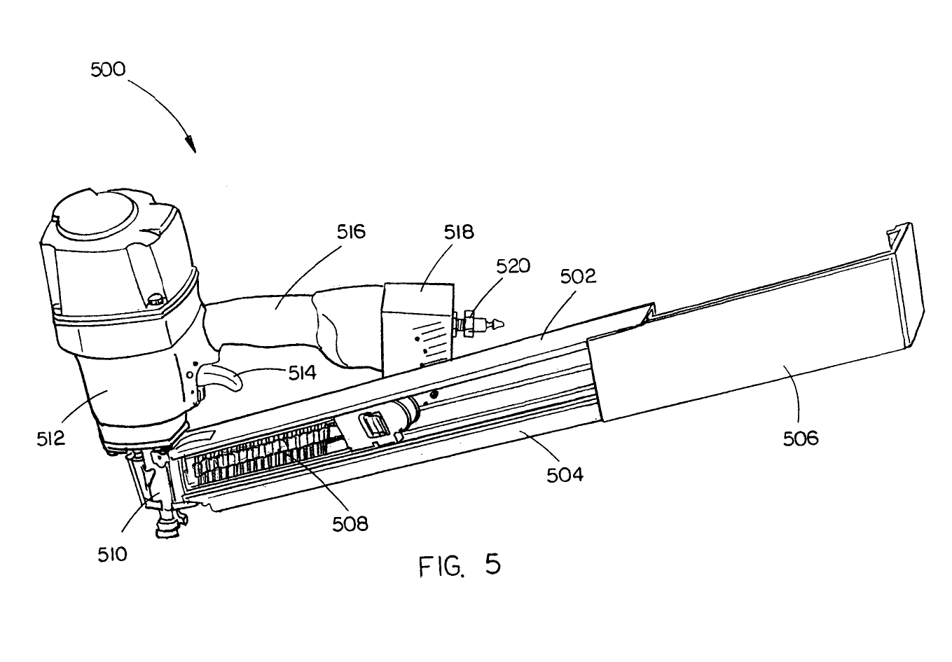

An adjustable angle nail gun 500 is shown in FIG. 5. In the current embodiment, the adjustable angle nail gun 500 includes an adjustable angle magazine 502 comprising a housing 504 slidably coupled with a cover 506. The cover 506 may be coupled with the housing 504 via a spring-loaded mechanism which allows the cover 506 to extend over the housing 504 and be retracted along the length of the housing 504. In the extended position the cover 506 provides a substantially closed system to the adjustable angle magazine 502. When the cover 506 is retracted along the length of the housing 504, a collated nail strip 508 may be loaded into the housing 504. In the current embodiment, the collated nail strip 508 is loaded into the housing 504 via a loading assembly 505. The loading assembly 505 provides a mechanism for the collated nail strip 508 to be inserted through a side of the housing 504 into a nail track of the housing, the nail track allowing the nails to advance down the hosing 504 and be received by an adjustable angle nose casting assembly 510. The loading assembly 505, in the preferred embodiment shown, is a slot disposed within the housing 504. Alternatively, the loading assembly 505 may be enabled in various configurations as contemplated by one of ordinary skill in the art. It is contemplated that the cover 506 may be enabled to retract and be removed from the housing 504. It is understood that the housing 504 and cover 506 may be of various configurations without departing from the scope and spirit of the present invention.

In the current embodiment, the adjustable angle nail gun 500, similar to the nail gun 100 and 200, comprises the adjustable angle nose casting assembly 510 to which the adjustable angle magazine 502 is pivotally coupled. The adjustable angle nose casting assembly 510 is coupled with a casing 512 of a nail driving assembly which is actuated through the use of a trigger 514 coupled with the casing 512. A handle 516 couples with the casing 512 and is further coupled with a fastening assembly 518 and a compressor connection assembly 520. The fastening assembly 518 adjustably couples with the adjustable angle magazine 502. It is understood that the features herein identified are similar to and may be read to include similar enablement as provided above for the similar features of FIGS. 1 through 4. For example, the adjustable angle magazine 502 may include a pusher assembly. Preferably, the pusher assembly may be an articulating pusher assembly. In the current embodiment, the pusher assembly may be adjustably integrated with the cover 506, thus the pusher assembly may be enabled to slide up and down the cover 506. It is contemplated that a mechanism, such as a spring loaded mechanism may couple with the pusher assembly, the spring loaded mechanism providing a constant force against the pusher and enabling its movement relative to the cover 506. Other configurations for providing a driving force to the collated nail strip 508 loaded within the housing 504, as provided by the pusher assembly described above, are contemplated and do not depart from the scope and spirit of the present invention.

In alternative embodiments, the nail gun 100, nail gun 200 and the adjustable angle nail gun 500 may be a pneumatic nail gun. Further, the nail gun 100, nail gun 200 and the adjustable angle nail gun 500 may be a spring-loaded nail gun assembly. The spring-loaded nail gun assembly utilizing electricity to drive a motor which may engage a spring that drives the driver blade. In another embodiment, the adjustable angle nail gun may be an electromagnetic nail gun assembly utilizing a solenoid to provide the driving force to the driver blade. The solenoid may include an electromagnetic coil with a sliding piston inside it. Other embodiments of the solenoid may include a spring assembly to draw the piston back in. In a still further embodiment, the nail gun 100, nail gun 200 and the adjustable angle nail gun 500 may be a combustion nail gun assembly utilizing a piston driven by the firing of gas in a combustion chamber to drive the driver blade. It is contemplated that the nail gun 100, nail gun 200 and the adjustable angle nail gun 500 may be configured as a motor driven nail gun. Thus, the adjustable angle nail gun may be configured with electric motors and the like. Further, the motors may include clutch assemblies for providing the needed force to operate the driver blade and drive a nail. The configuration of the motor and clutch assemblies employed may vary as contemplated by one of ordinary skill in the art without departing from the scope and spirit of the present invention.

In still further alternative embodiments, the nail gun 100, nail gun 200, and the adjustable angle nail gun 500 may further comprise a lockout assembly which may help reduce the number of instances of mis-fires due to incorrect nails being loaded into the nail driving assembly. The lockout assembly may be implemented as a trigger lockout assembly which may block inhibit the trigger from activating the nail driving assembly. In operation, the user of the nail guns may be unable to move the trigger of the trigger may dis-engage, when incorrectly positioned nails were loaded into the nail loading assembly. Alternatively, the lockout assembly may be implemented as a cover lockout assembly. In operation, this system may inhibit the cover from closing with the housing when incorrectly positioned nails are loaded. Other lockout configurations as contemplated by one of ordinary skill in the art may be employed without departing from the scope and spirit of the present invention.

It is believed that the present invention and many of its attendant advantages may be understood by the forgoing description. It is also believed that it may be apparent that various changes may be made in the form, construction and arrangement of the components thereof without departing from the scope and spirit of the invention or without sacrificing all of its material advantages. The form herein before described being merely an explanatory embodiment thereof. It is the intention of the following claims to encompass and include such changes.

1-14. (canceled)

15. An adjustable angle magazine for use with a nail gun, comprising:
a housing including a first end and a second end, the housing for storing nails and providing nails to a nail driving assembly of the nail gun, the first end of the housing for pivotally coupling with the nail driving assembly;
a cover including a first side, the cover removably coupled with the housing and for providing protection to the housing;
an adjustment assembly disposed proximal to the second end of the housing, the adjustment assembly for affixing the position of the housing relative to the nail gun; and
a side loading mechanism disposed on the first side of the cover, the side loading mechanism for enabling the loading of the nails,
wherein the side loading mechanism enables the loading of the nails through the first side of the cover and into the housing.

16-26. (canceled)

27. The adjustable angle magazine of claim 15, wherein the nail gun is selected from the group consisting of a spring-loaded nail gun, a pneumatic nail gun, an electromagnetic nail gun, a combustion nail gun, and a motor driven nail gun.

28-41. (canceled)

42. An adjustable angle nail gun, comprising:
a handle including a first end and a second end, the second end coupled with a fastening assembly;
a nail driving assembly coupled with the first end of the handle, the nail driving assembly for driving a nail;
an adjustable angle nose casting assembly coupled with the nail driving assembly, the adjustable angle nose casting assembly for receiving the nail and enabling the operational engagement of the nail driving assembly with the nail;
an adjustable angle magazine including a side, a first end for pivotally coupling with the adjustable angle nose casting assembly, and an adjustment assembly disposed proximal to a second end of the adjustable angle magazine, the adjustment assembly for coupling with the fastening assembly, the adjustable angle magazine for storing and providing the nail to the adjustable angle nose casting assembly;
a cover including a first side, the cover removably coupled with the adjustable angle magazine and for providing protection to the adjustable angle magazine; and
a side loading mechanism disposed on a the first side of the cover, the side loading mechanism for enabling the loading of the nails,
wherein the side loading mechanism enables the loading of the nails through the first side of the cover and into the adjustable angle magazine.

43-52. (canceled)

53. The adjustable angle nail gun of claim 42, wherein the adjustable angle nail gun is selected from the group consisting of a spring-loaded nail gun, a pneumatic nail gun, an electromagnetic nail gun, a combustion nail gun, and a motor driven nail gun.

54. (canceled)
